(19) United States
(12) Patent Application Publication
(10) Pub. No.: US 2006/0255054 A1
(43) Pub. Date: Nov. 16, 2006

(54) Tamper evident container

(76) Inventor: Terry Vovan, Rialto, CA (US)

Correspondence Address: LEON D. ROSEN;FREILICH, HORNBAKER & ROSEN, Suite 1220, 10960 Wilshire Boulevard, Los Angeles, CA, 90024, US

(21) Appl. No.: 11/414,847

(22) Filed: May 1, 2006

Related U.S. Application Data
(60) Provisional application No. 60/679,321, filed on May 10, 2005.

(51) Int. Cl. B65D 41/18; B65D 39/00; G01N 31/22; B65D 85/00; B65D 51/00

(52) U.S. Cl. 220/793; 206/459.1; 215/230; 220/377; 116/200

(57) ABSTRACT

An improvement to a container of the type that includes a vacuum formed transparent base and lid, the container having opposite sides that each forms a base flap (20) and a lid flap (22) that lie adjacent and parallel to each other, wherein the container indicates if it has been opened after a store clerk has loaded food into the container. An indicator sheet (34) lies between the base and lid and has cut-out characters (60) lying in holes (62) of a carrier (64), the carrier being bonded to the base flap and the characters being bonded to the lid flap. The container is opened by a person pulling up the lid flap, with the characters lifting out of their holes as they move up with the lid flap, and with the carrier that forms the character holes remaining on the base flap. When the lid is closed by pressing down the lid flap against the base flap, there will be some misalignment of the characters with the holes that they previously lay in, creating gaps that are readily noticeable. The gaps can spell much of a word such as “opened”.

### CROSS REFERENCE

Applicant claims priority from US Provisional patent application Ser. No. 60/679,321 filed May 10, 2005.

### BACKGROUND OF THE INVENTION

Food is often placed in a transparent plastic container that includes a base with a large volume cavity that holds the food and with a cover that closes the cavity. Buyers want to be assured that, after the food has been placed in the container, as by a clerk wearing plastic gloves at the food store, that the container has not been opened. There is a possibility that a customer will secretly open the container enough to taste a bit of the food before closing it (and possibly leave his/her germs in the food), and potential buyers want to know whether this has happened. A device that could be installed by the manufacturer of the containers, which could be almost automatically activated by a clerk at the food store when the container was filled and initially closed, and which indicated to customers when a container has been opened, would be of value. Food containers are sold at low costs so any such device should be of low cost and be easily activated by a store clerk.

### SUMMARY OF THE INVENTION

In accordance with one embodiment of the present invention, a container, especially a food container, is provided with a low cost and easily activated means that indicates when the container has been opened after goods such as food was loaded into the container. The container is of the type that includes a base and lid that are each constructed of deformed plastic sheet, with at least the lid being of transparent material. At least first sides of the base and lid form flaps that lie parallel and adjacent to one another. The indicating means includes a character sheet having cuts that form holes and forming characters within the holes. The character sheet portion other than the characters that lie in the holes, forms a carrier that lies outside the holes. The indicator sheet is usually an elongated strip that is placed between the base and lid flaps. When the indicator sheet is activated and the lid is closed, the carrier of the indicator sheet is adhesively bonded to the base flap, while the characters are adhesively bonded to the lid flap. When the container is next opened, the characters stick to the lid flap and pull out of holes in the carrier, and when the lid is closed again the characters will not fit precisely into the holes in the carrier that they were pulled out of. The misalignment is highly noticeable, and shows that the container was opened after the food was loaded.

The base and lid flap are latched together by a latch mechanism that causes the lid flap to shift rearward as it is being pushed down to close the container. As a result, the characters on the lid flap are shifted rearward before the lid is fully closed, causing misalignment.

The character sheet can be formed of an adhesive sheet that has sticky surfaces on both of its faces and that has front and rear edge sections. The characters lie between the front and rear edge sections of the adhesive sheet. Highly adhesive strips can be attached to the bottom of the front and rear edges of the adhesive sheet to cover only the carrier. The highly adhesive strips hold the carrier down to the base flap, while the tacky upper surface of the adhesive sheet pulls at least some of the characters our of the adhesive sheet as the lid flap is pulled up.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a top isometric view of a container of the present invention, shown in the initially closed position.

FIG. 2 is an isometric view of a portion of the container of FIG. 1 after food has been loaded into the container and the lid was closed, and the container has been again opened and closed.

FIG. 3 is a sectional view taken on line 3-3 of FIG. 1, and showing in phantom lines the lid being raised during opening of the container.

FIG. 4 is an enlarged sectional view of FIG. 3.

FIG. 5 is a plan view of a portion of FIG. 2, after the container has been opened and closed following the loading of goods 14 into the container.

FIG. 6 is an enlarged view of FIG. 3 showing the upper flap being initially lifted to open the container following the loading of goods into the container.

FIG. 7 is a view similar to FIG. 6, showing in phantom lines a portion of the lid flap in the course of closing, and showing in solid lines the lid flap pressed down fully to close the container, all following the opening step of FIG. 6.

FIG. 8 is a sectional view of an indicator sheet prior to its mounting on flaps of the container, and with peel-off protective sheets on its top and bottom faces.

FIG. 9 is a sectional view similar to FIG. 8, after the lower protective sheet has been removed and the indicator sheet has been pressed against the base flap.

FIG. 10 is a sectional view similar to FIG. 9, after the upper protective sheet has been removed from the indicator sheet, and the lid flap has been pressed down against the indicator sheet that lies on the base flap.

FIG. 11 is an enlarged view of a portion of the apparatus of FIG. 10, and with a black release and background strip.

### DESCRIPTION OF THE PREFERRED EMBODIMENTS

FIG. 1 illustrates a container 10 that is especially useful to hold food, which includes a base 12 that forms a food-holding cavity 14, and a cover or lid 16 that covers the cavity and that can be said to form top walls of the cavity. Both base and lid are constructed of vacuum formed transparent plastic sheets. The base and lid are each of generally rectangular shape and have peripheral portions at each of their four sides 24-27, in the form of base flaps 20 and lid flaps 22. The base flaps 20 and lid flaps 22 at each side of the container, lie in parallel planes, and lie adjacent to each other. As shown in FIG. 3, each flap 20, 22 has a mounted edge portion 30, 31 that merges with the rest of the base or lid, and has a free edge portion 32, 33 that is free to be bent up and down. Applicant places an indicator sheet 34 along at least one side of the container, with FIG. 1 showing a pair of indicator sheets 34, 36 at opposite sides of the container, to indicate when the container has been opened, the particular indicator strips being of white colors when viewed from above.

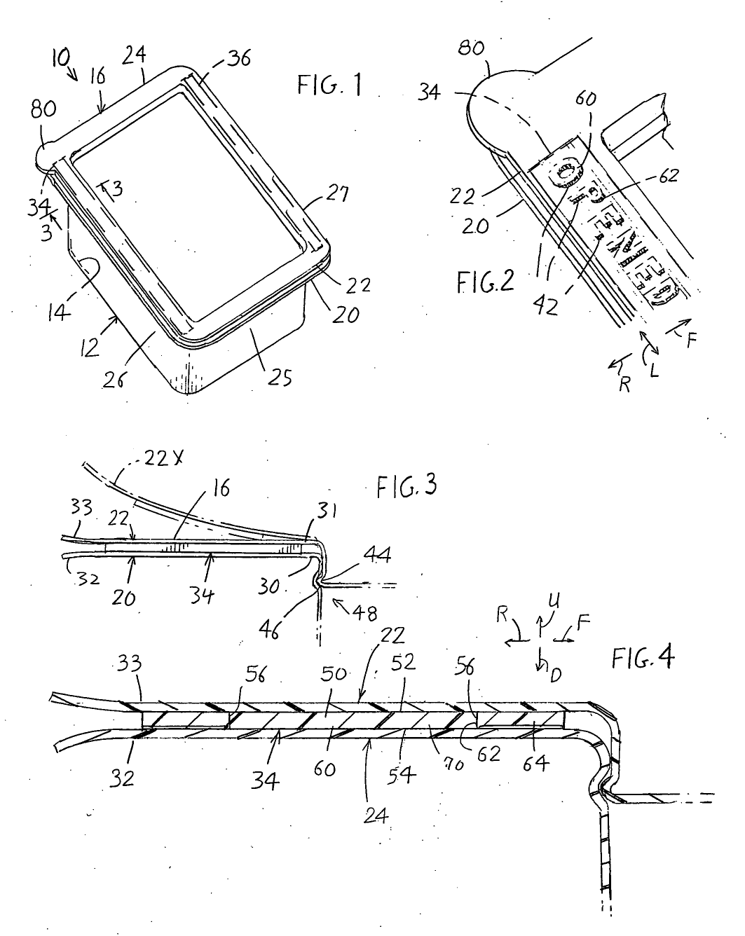

When the container has been initially closed after food has been placed in the container, the container appears “normal” with only two continuous (no gaps) white indicator strips 34, 36 seen lying at the container opposite sides between the base and lid . However, if the container thereafter has been opened and reclosed, then an anomaly appears as shown in FIG. 2, with gaps 42 and pieces of letters easily seen. The container still can be opened and closed, but the fact that it was initially opened is obvious.

FIG. 3 shows that the lid flap 22 can be opened by lifting the lid flap free edge portion 33 up away from the base flap free edge portion 32, with the lid flap at 22 X being bent to have a concave upper surface, until a lid projection 44 snaps out of a base recess 46. The lid projection 44 and base recess 46 form a releasable latch mechanism 48.

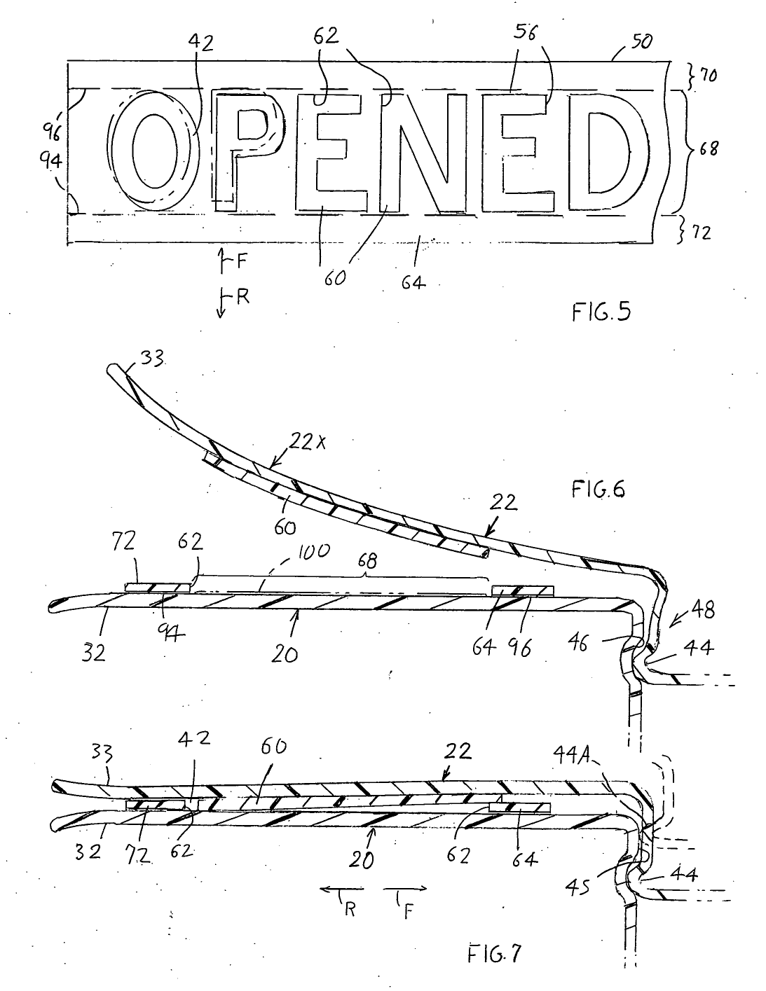

FIG. 4 shows the initially closed container, with an indicator sheet or strip 34 lying between the base and lid flaps. The indicator strip comprises a character sheet or strip (which is not necessarily elongated) 50 into which at least one character is cut. In FIG. 4, the character sheet 50 is an adhesive strip or band of “sticky” material with both its top surface 52 and its bottom surface 54 being adhesively held, with only moderate adhesive strength, respectively to the lid flap 22 and to the base flap 24. The term “adhesive strength” is used here to indicate the force required to pull off a unit area such as 0.5 inch² or peel it off. The indicator strip 34 has cuts 56 that form characters 60 such as letters, numbers, or a fanciful image and that form holes 62 in which the characters lie. The indicator strip also forms a carrier 64 in which the holes 62 have been formed. FIG. 5 shows the cuts 56 forming letter characters 60 that spell “OPENED” in a middle section or region 68 of the indicator strip. The middle region 68 lies between front F and rear R regions 70, 72 of the indicator strip.

Initially, the characters 60 lie in the openings or holes 62 of the carrier strip middle region, with the characters precisely matching the shape and positions of the holes and being precisely aligned with the holes, as a result of the letters being left in place in the strip after the cuts are made. However, when the lid and base flaps are separated to open the container to gain access to the food-holding cavity, some or all of the characters 60 stick to the lid flap while the carrier portion, or carrier 64 sticks to the base flap. This is because the character upper face is adhesively held to the lid flap by a first holding strength but the lower face of the character is not held to the base flap with the first holding strength. This is, the character lower face is held to the base flap by a lower or zero holding strength. Similarly, the carrier lower face is held to the base flap by a second holding strength, but the carrier upper face is held by a lower or zero holding strength to the lid flap.

FIG. 6 shows the lid flap 22X as the container is being opened, when the lid flap free edge portion 33 is bent upward before the lid projection 44 has pulled out of the base recess 46. The lid projection and base recess form the latch mechanism 48 that shifts the lid as it is replaced on the base, as described below. A character 60 has been pulled out from of a corresponding hole 62 in the carrier 64 to rise with the lid flap. At the same time, a part of the base flap 20 is usually held down by a person's finger and may be bent down. The carrier 64 of the indicator sheet remains stuck on the base flap 20.

FIG. 7 shows the lid flap 22 of FIG. 6 with the character 60 thereon as the lid flap is being closed onto the base flap 20, after having been previously opened. The lid flap (and to some extent the base flap, also) is bent differently during opening, when the lid flap is initially lifted, compared to bending that occurs during closing when the lid flaps may be simply pushed down. One difference is that the free edge portion 33 of the lid flap is usually pushed down towards the base flap 20, causing the character 60 to stick to the carrier 64, as the lid projection at 44A moves down across a base inner surface 45. As a result, the position of the character 60 in FIG. 7 has shifted forward F when the lid flap is closed, and the character 60 will not be fitted precisely into the hole 62 of the carrier 64. The result is that the character is shifted and/or skewed, with part of the character lying on top of the carrier 64 and part lying in the carrier hole 62 from which the letter was pulled out. The resulting gaps such as shown at 42 in FIG. 7 and FIG. 2, and some of the letters, spell the word “opened” and can be readily seen by a person. Thus, if a person sees some of the letters of “opened” and sees the messy arrangement of letters lying only partially in the corresponding holes, the person is informed that the container has been opened.

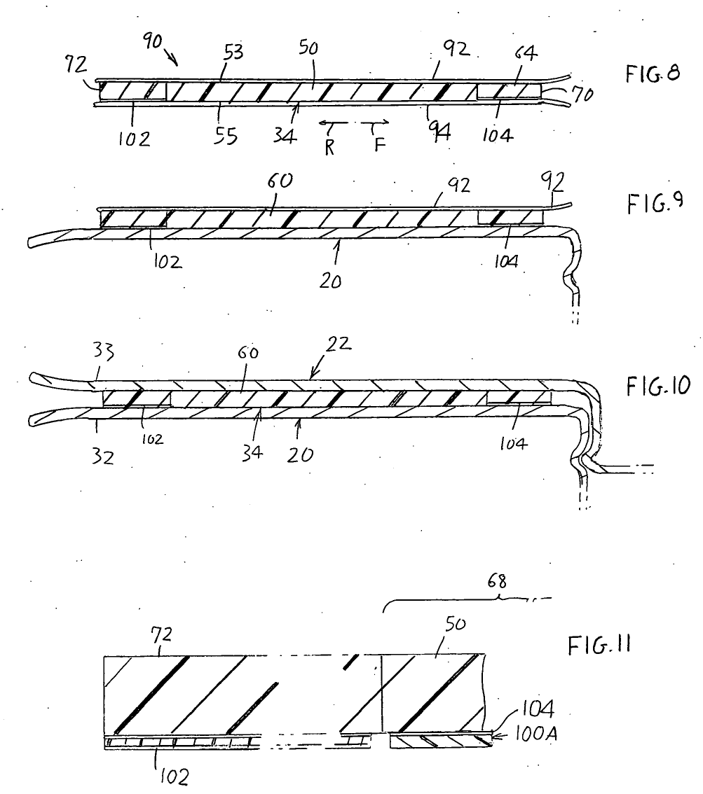

FIG. 8 shows a strip assembly 90 which includes the original indicator strip 34 as it is supplied to the manufacturer of containers. The strip assembly includes the adhesive sheet, or sheet of “sticky” material 50 and top and bottom peel-off protective sheets or strips, or protectors 92. 94 lying against the opposite faces 53, 55 of the character sheet 50. FIG. 8 shows highly adhesive layers 102, 104 lying on the bottom surface of the front and rear edge regions 70, 72 of the carrier 64, to securely hold the carrier to the base flap. FIG. 9 shows the indicator sheet after the bottom protector strip 94 has been removed, so only the upper protector strip 92 remains. As a result, the highly adhesive strips 102, 104 adhere to the base flap 20. The highly adhesive strips can be layers sprayed or brushed on by the manufacturer. Usually it is the manufacturer of the container base and lid who has removed the lower protector strip and pressed the highly adhesive strips against the base flap, and then ships the base and lid to food stores with the top peel-off protective sheet 92 in place.

FIG. 10 shows the assembly of FIG. 9, after food or other goods have been placed in the base cavity, a store clerk has peeled off the top protective sheet, and the lid flap has been pressed down towards the base flap, with only the indicator sheet 34 between them. The lid flap 22 has been pressed down firmly so the character 60 adheres to the lid flap. When the lid flap begins to be pulled up during a first opening of the container, as in FIG. 6, the carrier 64 remains on the base flap at least partially because of the highly adhesive layers 102, 104 that hold the front and rear edge regions of the carrier to the base flap. The characters 60 tend to move upward with the lid flap. This can be assured by placing a barrier indicated at 100 in FIG. 6, of non-adhesive release material, under the bottom of only the middle region 68 of the character sheet where the characters are located. Some or all of the characters will adhere to the lid flap 22. It is even possible to place a drop of highly adhesive material on the top of one or a few of the characters to assure that at least one character will stick to the lid flap.

When the lid is closed after it has been first opened, the character 60 will be shifted by the bending and displacement of the flaps, especially the lid flap, so the character such as 60 will not fit into the hole 62 in the carrier that it was pulled out of during opening of the container. Instead, as shown in FIG. 7, there will be uncovered gaps 42 in the carrier strip 64. A person looking at the indicator sheet 34 of FIG. 2 though the transparent lid flap 22 will see a largely white strip with gaps in the white strip where the holes have not been covered. The color seen though the gaps will be easily noticed. A black background strip can be placed under the adhesive sheet or even at the bottom of the base flap to enhance the contrast between the white strip and the gaps in it. FIG. 11 shows a black background strip 100A under the middle region 68, with a lower release surface that does not stick to the base flap and an upper adhesive layer 104 that sticks to the middle region. It is possible to merely paint the bottom of carrier middle region.

Where only one side of the container lid can be lifted because the other side is pivotally connected to the base, only one indicator strip is required. Where both sides of the container can be lifted so either one of the container opposite sides can be lifted to open the container, an indicator sheet is preferably placed on the flaps at both opposite sides of the container. Use of the term “strip” does not mean that a sheet is elongated. Such indicator strips can be placed at opposite sides of the container such as at the opposite long sides. Instead of a white strip, other contrasting colors can be used for the character sheet and the backup sheet. Although the indicator strip assemblies were designed for food containers, they can be used to hold containers for other goods.

Thus, the invention provides the combination of a container having at least one pair of base and lid flaps, and an indicator sheet or strip which indicates if the lid has been opened after the indicator strip was fully installed, which occurs after goods are loaded into the container. The indicator sheet has at least one cut that forms a hole and a character in the hole, and a carrier that surrounds the hole and the character therein. The hole could extend to the front or rear edge of the indicator sheet. The indicator sheet has a first adhesive surface that holds down the carrier to the base flap, and has another adhesive surface the holds the character to the lid flap when the lid flap is raised away from the base flap. There is zero or a lesser holding strength of the carrier for the lid and of the character for the base. As a result, when the lid flap is raised, the character is lifted out of its hole. When the lid flap is next lowered towards the base flap, the character will be lowered to a position offset from its original position, creating a gap between part of the character and the walls of the hole. The offsetting creates a gap which can be readily seen, to indicate to customers that the container has been opened since it was first closed after goods were loaded into the container. It is possible to adhere the character to the base and adhere the carrier to the lid, although that is not preferred.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A container that can indicate that it has been opened, which includes a base and lid that form a cavity between them when the lid is closed on the base, wherein the base and lid have opposite sides with at least one of said sides of said base and lid having parallel and adjacent flaps that are each resiliently bendable, including:
an indicator sheet which lies between and against said flaps and which has at least one cut that forms at least one character within the cut and that forms a carrier outside said at least one character, the indicator sheet having first and second faces that respectively form first and second faces of the character and of the carrier and that lie adjacent to first and second of said flaps, respectively, with the character first face being adhesively held with a first holding strength to said first flap but not to said second flap, and said carrier first face being adhesively held with a second adhesive strength to said second flap but not to said first flap, whereby when said flaps are pressed together and then separated the carrier sticks to the second flap and the at least one character sticks to the first flap.

2. The container described in claim 1 wherein:
said indicator sheet comprises a first adhesive sheet of material with sticky opposite faces that produces said first holding strength against said flaps, and at least a second adhesive sheet that bonds portions of said carrier lower face to said second flap with a holding strength that is greater than said first holding strength.

3. The container described in claim 1 wherein:
said indicator sheet has an upper surface of a first color, and including a layer of a contrasting color lying under said holes.

4. The container described in claim 1 wherein:
said base and lid have a latch mechanism that latches the lid in a closed position and that shifts a region of said lid horizontally before the lid is closed but as it is approaching a closed position on the base.

5. The combination of a container that includes a base and lid that form a cavity between them when the lid is closed, wherein the base and lid have opposite sides with at least one of said sides of said base and lid having parallel and adjacent flaps with at least the lid flap being resiliently bendable, the container including an indicator sheet which indicates if the lid has been opened and then closed after the indicator strip was fully installed, wherein:
said indicator sheet has through cuts that form holes that separate the indicator sheet into at least one character and into a carrier that surrounds the character, said indicator sheet having a first adhesive surface that holds down said carrier to a first of said flaps while a second adhesive surface holds said at least one character to the second of said flaps when the flaps are separated during pull up of the lid flap away from the base flap to open the container, to thereby pull the at least one character out of at least one corresponding hole in the carrier and make it difficult to replace the at least one character in precise alignment with walls of at least one hole when the lid is again closed.

6. The combination described in claim 5 wherein:
said lid and base have latch means that releasably latches the lid to the base and that shifts the lid as it is reclosed on the base.

7. The combination described in claim 5 wherein:
said indicator sheet has front and rear strip-shaped edge regions and a strip-shaped center region lying between said edge regions, said at least one character lying completely in said center region;
said first adhesive surfaces are strip-shaped surfaces that each lies on said first face of said carrier in a different one of said strip-shaped edge regions.

8. The combination described in claim 1 wherein:
said indicator sheet includes an adhesive sheet having top and bottom surfaces that are both moderately sticky, and a pair of strips that each fasten the bottom face of the indicator sheet at a different one of said edge regions to said second flap.

9. A method for assembling a container so it can indicate when the container has been opened after goods have been placed in the container and the container has been initially closed, wherein the container includes a base and lid that form a cavity between them, and the base and lid have opposite sides with at least one of said sides of said base and lid having parallel and adjacent base and lid flaps, comprising:
constructing an indicator sheet with at least one through cut forming a hole and at least one character in the hole, and forming a carrier around the hole;
placing the indicator sheet on an upper surface of the base flap and adhering the carrier of the indicator sheet to the base flap;
placing the lid on the base, pressing the lid flap against the indicator sheet, and adhering said at least one character to the lid flap more strongly than any adherence of said character to said base flap, whereby when the lid flap is pulled up during the next opening of the container the character lifts out of the hole and thereafter will not fit precisely into the hole when the lid is next closed.

10. The method described in claim 9 including:
bending down a free end of said lid flap against the carrier while shifting the lid horizontally in the course of closing the lid, so the character is laid down at a position shifted from the location from which it was initially lifted.
